(19) United States
(12) Patent Application Publication
(10) Pub. No.: US 2023/0066131 A1
(43) Pub. Date: Mar. 2, 2023

(54) FORWARD OSMOTIC SEPARATION SYSTEM AND METHOD

(71) Applicant: IDE WATER TECHNOLOGIES LTD., Kadima (IL)

(72) Inventor: Boris LIBERMAN, Kadima (IL)

(21) Appl. No.: 17/797,415

(22) PCT Filed: Mar. 11, 2021
(86) PCT No.: PCT/IB2021/052043

§ 371 Date: Aug. 3, 2022

(30) Foreign Application Priority Data
Mar. 13, 2020 (GB) 2003685.1

(51) Int. Cl. B01D 65/08; B01D 61/00; C02F 1/44

(52) U.S. Cl. CPC B01D 65/08; B01D 61/0022; C02F 1/445; B01D 2321/2066; B01D 2313/10; B01D 2319/02; C02F 2103/08

(57) ABSTRACT

Disclosed herein is a forward osmosis module for concentration and/or crystallization salts from an aqueous feed solution, the feed solution including seeds that surround an open semi-permeable membrane having free membrane portions forming an enclosure with a distribution pipe that introduces draw solution inside said enclosure. The feed solution penetrates into the enclosure as permeate from the feed side of the membrane to the draw solution side according to a Forward Osmosis process based on net driving pressure. The draw solution with permeate is evacuated from the enclosure via an outlet. A generator applies, at least periodically, a plurality of directional gauge pressure strokes PGs, directed from at least one of the draw solution inlet and outlet thereby effecting mechanical shaking of the free membrane portions for detachment of foulant.

### CROSS-REFERENCE TO RELATED APPLICATIONS

This application is a National Phase entry of International Application No. PCT/IB2021/052043 under § 371 and claims the benefit of GB Patent Application No. 2003685.1, filed Mar. 13, 2020, which is hereby incorporated by reference in its entirety.

### FIELD

This disclosure relates to an improved forward osmotic separation system and method.

The present disclosure relates to a method and system for concentration and/or crystallization of salts from aqueous solution by means of Forward Osmosis processes, such as those implemented in industrial wastewater treatment systems, mining tails water treatment, purification of non-potable water, such as desalination of sea water, brackish water, wastewater, and in food processing, pharmaceutical industry and high purity applications. The same system may be used for de-concentration of draw solution (sea water) by permeate penetration from feed solution (wastewater).

### BACKGROUND

Forward osmosis involves drawing feed water to be treated through a semi-permeable membrane 2 contained within a chamber 4 by the provision of a more concentrated draw solution on the other side of the membrane which creates a concentration gradient between the feed water and the concentrated draw solution. The membrane selectively permits water, but not salts, to pass into the concentrated solution and the water entering the concentrated solution dilutes the solution. The solutes are then removed from the dilute solution to generate potable product water, as illustrated in FIG. 1.

The semi-permeable membranes can become clogged during normal operation through the accumulation of fouling media, such as minerals, organic particles, scaling microcrystals, bacteria and algae, on the membrane surface. A fouled membrane provides reduced separability of the dissolved salts, has a reduced flux rate and an increased pressure loss. Therefore, in order to maintain an efficient Forward Osmosis process, it is necessary to clean periodically the semi-permeable membrane.

Furthermore, forward osmosis performance is also limited by concentration polarization (CP), being the build-up of concentration gradients both inside and around the Forward Osmosis membranes during operation. In forward osmosis the feedwater solution becomes more concentrated on one side of the membrane and the draw solution becomes more diluted at the other, reducing the differential osmotic pressure and thus reducing solvent flow. These gradients reduce the effective osmotic pressure difference across the membrane and limit the attainable water flux. In this respect, when pressure is applied to the feed side of a membrane during the forward osmosis process, the solute is partially or totally retained by the membrane and will accumulate on the surface, while the solvent passes through the membrane more freely. Due to the membrane's solute retention, the concentration of the solute in the permeate is lower than the concentration in the feed. The concentration of the solute gradually increases on the surface of the membrane, due to solute accumulation from convective flow. At some point, the convective solute flow to the surface of the membrane will be balanced by the solute flux through the membrane and the diffusive flow from the membrane surface to the permeate side of the membrane. A concentration polarization profile, in which the concentration at the membrane surface (Cm) is typically higher than the permeate side of the membrane, will be established in the boundary layer.

This Concentration Polarization (CP) is the dominant component preventing effective operation of a Forward Osmosis process. In FO process CP is different in Draw solution site and in Feed solution. In feed solution CP is “Concentrative” (POrcp); in Draw solution site it is “Dilutive” (POscp). (See, e.g., Impacts of operating conditions and solution chemistry on osmotic membrane structure and performance. Mavis C. Y. Wong, Kristina Martinez, Guy Z. Ramon, Eric M. V. Hoek; Desalination 287 (2012) 340-349).

It is an object of the present disclosure is to provide an improved method and system for enhancing the efficiency of a forward osmosis process.

It is a further object of the present disclosure to provide an improved method and system for reducing fouling of membranes used in a FO process.

### SUMMARY

A first aspect of the present disclosure provides a forward osmosis separation system comprising:

a feed solution inlet for introducing a feed solution into a housing;

a draw solution distribution pipe for introducing draw solution into an internal enclosure, the draw solution having a higher salt concentration relative to the feed solution;

at least one semi-permeable membrane in the housing, said membrane being at least partially open to provide free membrane portions, the membrane forming the internal enclosure with the draw solution distribution pipe; and

at least one outlet for removal of a permeate solution from the enclosure, wherein a plurality of seeds are provided in the feed solution surrounding the enclosure and at least one of the draw solution inlet or outlet has a generator for providing at least periodically a plurality of directional pressure strokes in at least one of the draw and permeate solutions.

The combination of seeding in the feed solution, open and expanded membranes to provide free membrane portions together with the application of a plurality of directional pressure strokes in the draw or permeate solutions reduces fouling of the membrane and build-up of a concentration polarization, thereby providing a self-cleaning system having increased efficiency. Normally seeding cannot be used together with tight arranged membrane surface where distance for feed solution is less than one millimeter (feed spacer). Only when an open membrane is provided is it possible to use seeding effectively due to the larger distance between membrane. The opening and expanding of the membrane in large volume of feed solution, allows large amplitude membrane oscillation and enables the inclusion of a high seeding concentration.

Optionally, the system may further include a generator for applying a pulsed flow regime in at least one of the draw solution or the feed solution for increasing shearing force to achieve enhanced removal of concentration polarization and for preventing scale formation.

Preferably, an inlet for the draw solution is provided at a lower end of the distribution pipe and the outlet for the removal of the permeate solution is provided at an upper end of the distribution pipe. The directional pressure strokes are preferably applied via the distribution pipe. The directional pressure stokes may be provided by a generator provided in the draw solution inlet or the permeate solution outlet forming part of the distribution pipe. The generator may comprise piston or diaphragm, a pump or a valve.

In one embodiment, the system may include multiple internal enclosures provided by multiple semi-permeable membranes, the multiple internal enclosures being provided in a single housing with a common distribution pipe providing a feed solution inlet and permeate solution outlet. Preferably, the draw solution inlet introduces draw solution to a first enclosure, preferably via a lower end of the distribution pipe and the outlet of the first enclosure, preferably being an upper end of the pipe line for the first enclosure introduces solution into the next enclosure as the feed solution inlet. Again, a plurality of seeds is provided in the feed solution in the housing surrounding all the enclosures and a plurality of directional pressure strokes are applied, at least periodically, to the draw solution and/or permeate solution. The generator for application of the pressure strokes may be provided in a first and/or last draw solution inlet or permeate outlet or may be provided in the individual inlets and outlets of each internal enclosure.

A second aspect of the present disclosure provides a method for increasing driving force and water flux across a semi-permeable membrane during a forward osmosis process, the method comprising:

introducing a feed solution stream into a housing containing a semi-permeable membrane, the membrane being at least partially open and having free membrane portions, the membrane forming an internal enclosure wherein the feed solution surrounds the internal enclosure and includes a plurality of seeds;

introducing a draw solution stream into the internal enclosure, the draw solution stream having a higher salt concentration relative to the feed solution stream;

removing a permeate stream from the enclosure; and

at least periodically applying a plurality of directional pressure strokes in at least one of the draw or permeate streams.

Preferably, the draw solution stream is introduced into the internal enclosure through a lower end of a distribution pipe forming part of the enclosure. The permeate stream is preferably removed from an upper end of the distribution pipe. More preferably, the application of directional pressure strokes occurs in the distribution pipe.

The plurality of seeds may be continuously or intermittently introduced into the housing with the feed solution. Alternatively, the seeds may be introduced during initiation of the process only. The process may also comprise formation of seed particles in the feed solution stream.

Optionally, the process may further include applying a pulsed flow regime in at least one of the draw solution or the feed solution for increasing shearing force to achieve enhanced removal of concentration polarization and for preventing scale formation.

### BRIEF DESCRIPTION OF THE DRAWINGS

Embodiments of the disclosure shall now be described, by way of example only, with reference to the accompanying drawings in which:

FIG. 1 is a schematic diagram of a prior art forward osmosis system;

FIGS. 2 and 3 are sectional views through a forward osmosis module, according to one embodiment of the present disclosure;

FIG. 4 is a section A-A through a free membrane portion 23 of FIG. 2 demonstrating membrane fouling and concentration polarization at the membrane;

FIG. 5 is a section B-B through a free membrane portion 23 of FIG. 2 demonstrating a reduction in membrane fouling and concentration polarization at the membrane;

FIG. 6 is a sectional view through a forward osmosis unit having multiple forward osmosis modules, according to another embodiment of the disclosure; and

FIG. 7 illustrates the arrangement of the multiple free membrane portions of the multiple forward osmosis modules shown in FIG. 6.

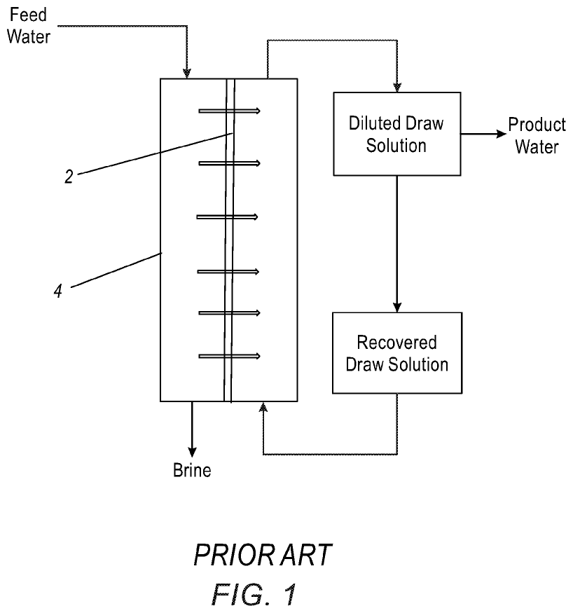

### DETAILED DESCRIPTION

The present disclosure relates to an improved method and system for reducing and/or preventing concentration polarization and/or membrane fouling in a forward osmosis process.

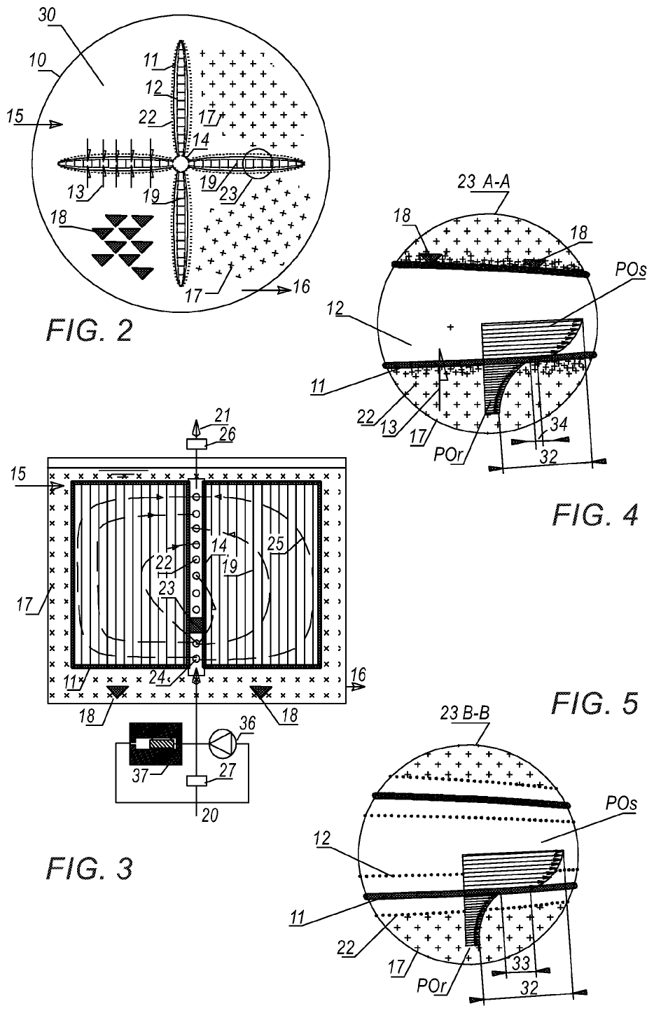

FIGS. 2 and 3 of the accompanying drawings illustrate a Forward Osmosis (FO) module 10 for concentration and/or crystallization of salts 18 from an aqueous feed solution 30, such as sea water or brackish water. The module 10 has a semi-permeable membrane, arranged to be at least partially open as opposed to a tightly wound spiral membrane, the membrane having free membrane portions that form an enclosure 11 with a pipeline 14 which introduces draw solution 19 inside said enclosure at a lower end of the pipe 14. The enclosure 11 is positioned freely and openly in the feed solution 30, having an osmotic pressure (POr) and gauge pressure (PGr), the feed solution 30 entering the external space around the enclosure 11 via inlet 15. Seeding particles 17 are provided in the feed solution 30 in which the free membrane portions are located. The draw solution 19, having a gauge pressure (PGs) and osmotic pressure (POs), enters inside said enclosure via inlet 20. This creates a pressure gradient whereby at least part of the feed solution 30 penetrates into enclosure 11 as permeate 13 by FO based on net driving pressure defined by the balance of the gauge and osmotic pressures PGr, POr, POs and PGs. The draw solution 19 with permeate 13 is evacuated from enclosure 11 via upper end of pipeline 14 and outlet 21 and this can be further treated to provide product water (not shown).

The efficiency of this process is reduced both by membrane fouling (i.e. salt accumulation 18 on the feed side of the membrane—see FIG. 4) and concentration polarization at the membrane (illustrated by symbol ‘+’ in FIG. 4). Concentration Polarization is not simply dictated by the difference in concentrations of the feed and draw solutions. In reality, the net driving osmotic pressure is also effected by polarization that takes place within the support layer of the membrane. When CP is “Concentrative”, polarization also takes place on the external surface of the enclosure 11 containing the membrane which faces the feed solution 30. The mechanism of CP “Concentrative” formation relates to solute ions remaining in the vicinity of the membrane when solvent (permeate) 13 penetrates the membrane from feed solution 30 to the draw solution 19 via Forward Osmosis process based on net driving pressure defined by the balance of the gauge and osmotic pressures PGr, POr, POs and PGs.

CP “Dilutive” POscp takes place on the internal surface of enclosure 11 which faces the draw solution 19. Mechanism of CP “Dilutive” relates to dilution of draw solution by permeate 13 in internal membrane vicinity. It is known that concentration polarization very significantly diminishes the driving force that allows for permeate 13 penetration. Some distance from membrane feed surface the osmotic pressure of the Feed solution is POr but on the membrane it may be almost twice this concentration POrcp. Similarly, some distance from internal surface, the osmotic pressure of Draw solution is POs but, on the membrane, it can be almost half this concentration POscp. FIG. 4 shows the difference 32 between osmotic pressures POr and POs at some distance from membrane surface from both sides of membrane, and difference 34 between osmotic pressures POrcp and POscp on the surface from both sides of membrane. The actual NDF is the force 34 based on concentration polarization.

The present disclosure provides means to diminish fouling and scaling on the membrane, as well as moving the concentration polarization layers and seeding particles away from the membrane, thereby reducing the need for membrane cleaning and increasing the efficiency of the FO process. This is achieved by the introduction of seed particles 17 into the module 10 surrounding the free membrane portions that form the enclosure 11 and combining this with the application, at least periodically, of a plurality of directional gauge pressure strokes more the 1 mm amplitude PGs, directed from the draw solution inlet 20 and/or the draw solution outlet 21 thereby effecting mechanical oscillation of the free membrane portions 11 from position 12 to position 22 to detach foulant from the membrane and reduce the concentration polarization at the membrane surface (see FIGS. 2, 3 and 5).

The application of periodical directional pressure strokes to a reverse osmosis process is described in the Applicant's earlier publication WO 2016/024179, the entire contents of which are incorporated herein by reference thereto. The generation of water pressure strokes causes oscillation of thousands of displaceable free membrane portions of the semi-permeable membrane, serving to reduce concentration polarization across the membrane support layer and prevent membrane fouling. In WO 2016/024179, the tight arrangement of the membrane limits the amplitude of oscillation to a few microns. In contrast, embodiments of the present disclosure use open and expanded membranes to allow oscillation of a few centimeters. An innovation step is in opening and expand membrane in large volume of feed solution, allowing large amplitude membrane oscillation and the implementation of a high concentration of seed particles.

The system and process of embodiments of the disclosure may also include, optionally applying during at least part of the FO process, a pulsed flow regime in at least one of the draw solution and/or feed solution stream, thereby increasing shearing force for achieving enhanced removal of concentration polarization seeding particles from the membrane surface and for preventing scale formation, thereby enhancing the Forward Osmosis process.

FIG. 3 of the accompanying illustrates a preferred system of the present disclosure wherein the plurality of directional pressure strokes are provided by one or more of the following: a generator of pressure strokes installed in the draw solution inlet 27, such as a piston or diaphragm 37 and/or the draw solution outlet 26 which is configured to push or pull draw solution into or from the enclosure 11. Alternatively, or additionally, the generator may be configured to pulse-wise pump in 36, and/or pulse-wise discharge from the enclosure 11 the draw solution 19 via input 27 and/or output 26, for example by opening and closing a valve.

Any appropriate seed material may be introduced into the module 10 surrounding the membrane enclosure 11. It is to be appreciated that the seed particles may be introduced continuously, periodically or at initiation only. The seeding process prevents crystallization of the salts at the most concentrated part of the feed solution, instead causing crystallization of the salts on the seed particles.

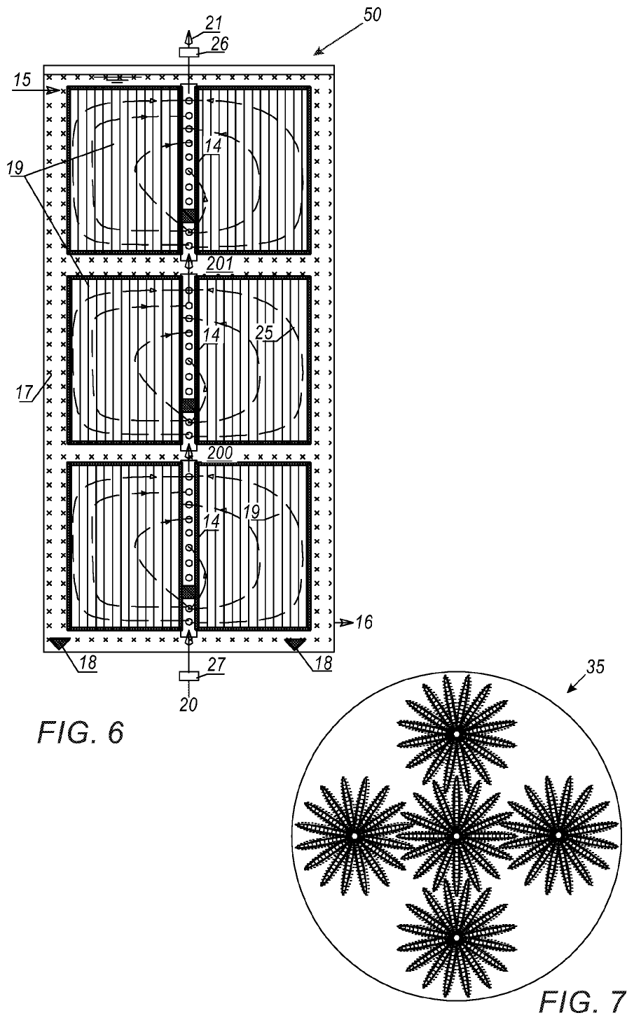

FIGS. 6 and 7 illustrate an alternative system according to the present disclosure wherein a housing 50 includes a plurality of free membrane portion enclosures 11 connected by a distribution pipe 14, wherein feed solution 30 is introduced into the housing by a common inlet 15 and the draw solution 19 moves from one enclosure to another whereby outlet 200 forms the inlet 201 of an adjacent enclosure, until the permeate and draw solution reaches the final outlet 21 where it is evacuated from the housing and can be further treated to provide product water (not shown). Again, seed particles 17 surround the free membrane portions by their placement in the feed solution 30 and directional pressure strokes can be applied periodically from at least one of the draw solution inlet or outlet, for example by means of a piston or diaphragm or a pulse-wise pump.

In this manner, embodiments of the present disclosure serve to diminish concentration polarization on both sides of the membrane thereby increasing the driving force (NDF^{cp}) and the FO flux 13 (see FIGS. 2 and 4) and reduces scaling on the external surface of the membrane enclosure 11 by combining seeding with the application of a plurality of directional pressure strokes to free membrane portions of a semi-permeable membrane surrounded by the seeding, and optionally applying a pulsed-flow regime in at least one of the feed or draw solutions.

1. A forward osmosis separation system comprising:
a feed solution inlet for introducing a feed solution into a housing;
a draw solution distribution pipe for introducing draw solution into an internal enclosure within the housing, the draw solution having a higher salt concentration relative to the feed solution;
at least one semi-permeable membrane in the housing, said membrane being at least partially open to provide free membrane portions, the membrane forming the internal enclosure with the draw solution distribution pipe;
and
at least one outlet for removal of a permeate solution from the enclosure, wherein a plurality of seeds are provided in the feed solution surrounding the enclosure and at least one of the draw solution inlet or outlet has a generator for providing at least periodically a plurality of directional pressure strokes in at least one of the draw and permeate solutions.

2. The forward osmosis separation system as claimed in claim wherein a generator is provided for application of a pulsed flow regime in at least one of the draw solution or the feed solution for increasing shearing force to achieve enhanced removal of concentration polarization and for preventing scale formation.

3. The forward osmosis separation system as claimed in claim 1, wherein an inlet for the draw solution is provided at a lower end of the distribution pipe and the outlet for removal of the permeate solution is provided at an upper end of the distribution pipe.

4. The forward osmosis separation system as claimed in claim 1, wherein the directional pressure strokes are applied via the distribution pipe.

5. The forward osmosis separation system as claimed in claim 1, wherein the at least one generator for applying directional pressure stokes is provided in at least one of the draw solution inlet or the permeate solution outlet and is selected from at least one of a piston, diaphragm, a pump and a valve.

6. The forward osmosis separation system as claimed in claim 1, wherein the system has multiple internal enclosures provided by multiple semi-permeable membranes, the multiple internal enclosures being provided in a single housing with a common distribution pipe providing a feed solution inlet and permeate solution outlet.

7. The forward osmosis separation system as claimed in claim 6, wherein the draw solution inlet introduces draw solution to a first enclosure, preferably via a lower end of the distribution pipe and the permeate solution outlet of the first enclosure, preferably being an upper end of the distribution pipe of the first enclosure, introduces solution into the next enclosure as the feed solution inlet.

8. The forward osmosis separation system as claimed in claim 6, wherein the generator for application of the pressure strokes is provided in a first and/or last draw solution inlet or permeate solution outlet.

9. The forward osmosis separation system as claimed in claim 6, wherein the generator for application of the pressure strokes is provided in each draw solution inlet and/or permeate solution outlet of each internal enclosure.

10. A method for increasing driving force and water flux across a semi-permeable membrane during a forward osmosis process, the method comprising:
introducing a feed solution stream into a housing containing a semi-permeable membrane, the membrane being at least partially open and having free membrane portions, the membrane forming an internal enclosure wherein the feed solution surrounds the internal enclosure and includes a plurality of seeds;
introducing a draw solution stream into the internal enclosure, the draw solution stream having a higher salt concentration relative to the feed solution stream;
removing a permeate stream from the enclosure; and
at least periodically applying a plurality of directional pressure strokes in at least one of the draw or permeate streams.

11. The method according to claim 10, wherein the draw solution stream is introduced into the internal enclosure through a lower end of a distribution pipe forming part of the enclosure.

12. The method according to claim 11, wherein the permeate stream is removed from an upper end of the distribution pipe.

13. The method according to claim 11, wherein the directional pressure strokes are applied within the distribution pipe.

14. The method according to claim 10, further comprising introducing the plurality of seeds continuously into the housing with the feed solution.

15. The method according to claim 10, further comprising intermittently introducing the plurality of seeds into the housing with the feed solution.

16. The method according to claim 10, further comprising introducing the plurality of seeds into the housing with the feed solution during initiation of the process only.

17. The method according to claim 10, further comprising applying a pulsed flow regime in at least one of the draw solution stream and the feed solution stream for increasing shearing force to achieve enhanced removal of concentration polarization and for preventing scale formation.
